(19) United States
(12) Patent Application Publication
(10) Pub. No.: US 2009/0178866 A1
(43) Pub. Date: Jul. 16, 2009

(54) METHOD FOR OPERATING A DRIVETRAIN

(75) Inventors: Christian SCHWEMER, Sigmarszell (DE); Martin-Joachim Bader, Wolpertswende (DE)

Correspondence Address: DAVIS & BUJOLD, P.L.L.C., 112 PLEASANT STREET, CONCORD, NH, 03301, US

(73) Assignee: ZF Friedrichshafen AG, Friedrichshafen (DE)

(21) Appl. No.: 12/349,792

(22) Filed: Jan. 7, 2009

(30) Foreign Application Priority Data
Jan. 14, 2008 (DE) 102008000045.0

(51) Int. Cl. B60W 10/04; B60W 20/00

(52) U.S. Cl. 180/65.265; 180/65.275

(57) ABSTRACT

A method for operating a drive train of a motor vehicle that includes at least a hybrid drive with a combustion engine and an electric motor, a transmission arranged between the hybrid drive and a drive output, and a clutch arranged between the combustion engine and the electric motor, such that when the combustion engine is stopped during electric operation of the drive train the combustion engine can be started by engaging the clutch between the combustion engine and the electric motor. Before the combustion engine is started by the electric motor at least one friction element, which is arranged between the hybrid drive and the drive output, is operated at a slipping limit.

Priority from German Application DE 10 2008 000 045.0 filed Jan. 14, 2008.

### FIELD OF INVENTION

The invention concerns a method for operating a motor vehicle drivetrain comprising at least a transmission and a hybrid drive.

### BACKGROUND OF INVENTION

The main components of a drivetrain of a motor vehicle are a drive aggregate and a transmission. The transmission converts torques and speeds and thereby transmits the traction provided by the drive aggregate. The present invention concerns a method for operating a drivetrain which comprises at least a transmission and, as the drive aggregate, a hybrid drive with a combustion engine and an electric motor.

A drivetrain with a hybrid drive is powered during electric operation exclusively by the electric motor, so that during such operation the combustion engine is decoupled from the output of the drivetrain. During electric operation the combustion engine can either remain running or stop. In hybrid operation both the combustion engine and the electric motor are coupled to the drive output of the drivetrain.

The present invention concerns a method for operating a drivetrain of this type, in such manner that when the combustion engine is stopped during electric operation of the drivetrain, the combustion engine can be started by the electric motor very comfortably and with a short reaction time by engaging a clutch arranged between the combustion engine and the electric motor. This has not hitherto been possible with the methods known from previous practice.

### SUMMARY OF THE INVENTION

Starting from that point, the invention addresses the problem of providing a new type of method for operating a drivetrain comprising a transmission and a hybrid drive.

This problem is solved by a method for operating a drivetrain of a motor vehicle comprising at least a transmission and a hybrid drive. According to the invention, before the combustion engine is started by the electric motor at least one friction element operated by friction force, arranged between the hybrid drive and the drive output, is operated at a slipping limit.

With the help of the method according to the invention, during electric operation of the drivetrain the combustion engine can be started by the electric motor very comfortably and with a short reaction time. To do this, already before the combustion engine is started at least one friction element operated by friction force, arranged between the hybrid drive and the drive output, is operated at a slipping limit such that the drive output is decoupled and the combustion engine can be started by the electric motor in a short time and very comfortably.

According to an advantageous further development of the invention, before the combustion engine is started by the electric motor, at least one friction element, which is operated by friction force and arranged between the hybrid drive and the drive output, is operated at the slipping limit when, from a charge condition of a battery and/or from a reserve torque of the electric motor, imminent starting of the combustion engine is concluded. In contrast, when no imminent starting of the combustion engine is concluded from the charge condition of a battery and/or from the reserve torque of the electric motor, the friction element operated by friction force is completely engaged

### BRIEF DESCRIPTION OF THE DRAWINGS

Preferred further developments of the invention emerge from the description given below. Example embodiments of the invention, to which the latter is not limited, are explained in more detail with reference to the drawing, which shows:

FIG. 1: Diagram to clarify the method according to the invention for operating a drivetrain of a motor vehicle comprising at least a transmission and a hybrid drive.

### DETAILED DESCRIPTION OF THE INVENTION

The present invention concerns a method for operating a drivetrain of a motor vehicle comprising at least a transmission and a hybrid drive. The hybrid drive of such a drivetrain comprises a combustion engine, an electric motor, and a clutch arranged between the combustion engine and the electric motor of the hybrid drive.

During electric operation the clutch between the combustion engine and the electric motor is disengaged, so the combustion engine is decoupled from a drive output of the drivetrain. On the other hand, during hybrid operation the clutch between the combustion engine and the electric motor is engaged, so that both the electric motor and the combustion engine are coupled to the drive output of the drivetrain.

During electric operation of the drivetrain, when the clutch between the electric motor and the combustion engine is disengaged, if a stopped combustion engine has to be started or boosted into operation by the electric motor, the clutch between the combustion engine and the electric motor must be engaged. When this is done, however, for comfort reasons the starting or boosting of the engine must not be perceptible at the drive output. Furthermore, it should be possible to start or boost the combustion engine within a short reaction time.

Now, the present invention concerns a method for operating a drivetrain with a hybrid drive and a transmission, whereby these characteristics can be ensured.

In the context of the present invention, before the combustion engine is started by the electric motor and accordingly before the engagement of the clutch between the combustion engine and the electric motor, at least one friction element operated by friction force and arranged between the hybrid drive and the drive output is operated at the slipping limit. The friction element operated by friction force at the slipping limit, arranged between the electric motor of the hybrid drive and the drive output, can be a transmission-internal friction element made as a clutch or brake, or even a transmission-external friction element made, for example, as a starting clutch.

In the context of the present invention it is accordingly proposed to hold a friction element arranged between the electric motor of the hybrid drive and the drive output at the slipping limit before the combustion engine is started or boosted into action, so that when the combustion engine is to be started or boosted, decoupling from the drive output can take place immediately so that the combustion engine can be started by the electric motor with no further reaction time while ensuring a high level of comfort.

According to an advantageous further development of the present invention, before the combustion engine is started, at least one friction element operated by friction force and arranged between the hybrid drive and the drive output is operated at the slipping limit when it is determined from a charge condition of a battery of the drivetrain and/or from a reserve torque of the electric motor of the hybrid drive that an imminent start of the combustion engine is necessary.

When the charge condition of the battery falls below a limit value, then from the charge condition of the battery it can be concluded that starting of the combustion engine is imminent. And when the reserve torque of the electric motor is no longer sufficient to start the combustion engine, then from the reserve torque of the electric motor it can be concluded that starting of the combustion engine is imminent.

When, from the charge condition of the battery and/or the reserve torque of the electric motor, it cannot be determined that starting of the combustion engine is imminent, then the friction element operated by friction force is preferably engaged completely.

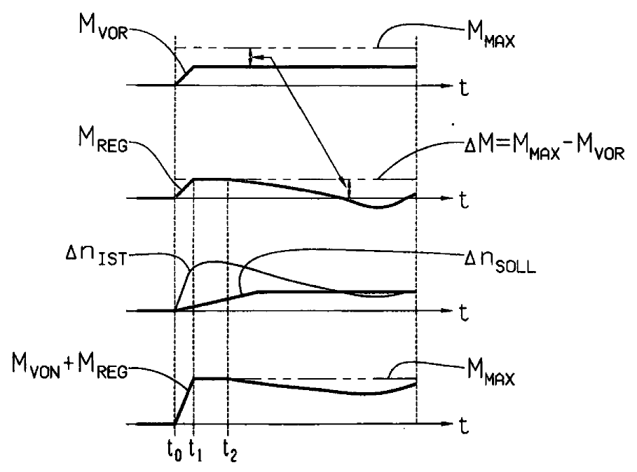

Below, the method according to the invention will be described with reference to the diagram of FIG. 1, for the case when the drivetrain is running in electric operation and changes from a stationary operating condition to the operating condition of creeping forward, such that during creeping the combustion engine is to be started by the electric motor. Thus, FIG. 1 shows plots, as a function of time t, of a total of five signal variations with time, namely the time variation of a torque M VOR determined by an anticipatory control and to be transmitted by the friction element, a time variation of a torque M REG to be transmitted by the friction element as a function of a speed difference regulation, a signal variation over time of the sum of these two torques M_{VOR}+M_{REG}, and time variations of speed differences, namely a nominal speed difference Δn SOLL and an actual speed difference Δn_{IST}.

At time t₀ the drivetrain changes from the stationary operating condition to the creeping operating condition. When stationary the motor vehicle is at rest, a driver thereof actuates a brake pedal, the combustion engine of the hybrid drive stops and the electric motor of the hybrid drive stops or turns at a speed needed to maintain the system in readiness.

In creeping mode the driver does not actuate the brake pedal, the combustion engine is off and the electric motor turns at a creeping speed, for example to enable a motor vehicle operated on flat ground to roll.

In the creeping operating condition, to ensure that a friction element between the hybrid drive and the drive output is operated at the slipping limit, an anticipatory control system produces at the friction element the torque M_{VOR}, such that this torque M_{VOR} must not exceed a maximum permissible torque M_{MAX}.

Superimposed on this anticipatory-control-dependent torque M_{VOR} is a torque M_{REG} that depends on a speed difference regulation, and as shown in FIG. 1 the speed-difference-regulation-dependent torque also has an upper limit, which corresponds to the difference ΔM between the maximum permissible torque M_{MAX} and the anticipatory-control-dependent torque M_{VOR} . Accordingly, ΔM=M_{MAX}−M_{VOR}.

In this way it is ensured that the sum of the anticipatory-control-dependent torque M_{VOR} and the speed-difference-regulation-dependent torque M_{REG} does not exceed the maximum permissible torque M_{MAX}.

With the change from the stationary operating condition to the creeping operating condition at time t₀. the speed difference regulation is initiated by setting the nominal speed difference n_{SOLL} to the actual speed difference n_{IST} at time t₀ and subsequently adjusting it to the actually desired nominal speed difference.

In this way the effect of the speed difference regulation can be limited, for example to avoid a reverse movement of a piston for actuating the friction element and so as not to exceed the maximum permissible torque M_{MAX} .

The method according to the invention ensures that a friction element arranged between the hybrid drive and the drive output is operated at the slipping limit, so that when the combustion engine should be started, it can be started very comfortably and within a short reaction time. A further advantage of the method is that if the driving resistance increases while the motor vehicle is creeping, the torque transmitted by the friction element is automatically limited to the maximum permissible torque M_{MAX} and no after-regulation of the torque takes place, so that driving of the motor vehicle uphill without actuating the accelerator pedal is avoided.

1-6. (canceled)

7. A method for operating a drive train of a motor vehicle, the drive train comprising at least a hybrid drive with a combustion engine and an electric motor, a transmission being arranged between the hybrid drive and a drive output, and a clutch being arranged between the combustion engine and the electric motor such that when the combustion engine is stopped, during electric operation of the drive train, the combustion engine is started by engaging the clutch between the combustion engine and the electric motor, the method comprising the step of:
before the combustion engine is started by the electric motor, operating by friction force at a slipping limit at least one friction element which is arranged between the hybrid drive and the drive output.

8. The method according to claim 7, further comprising the step of operating one of a transmission-internal friction clutch or brake at the slipping limit before starting the combustion engine.

9. The method according to claim 7, further comprising the step of operating a transmission-internal friction clutch at the slipping limit before starting the combustion engine.

10. The method according to claim 7, further comprising the step of operating the at least one friction element, which is arranged between the hybrid drive and the drive output, at the slipping limit before starting the combustion engine with the electric motor, if it is determined from at least one of a charge condition of a battery and a reserve torque of the electric motor that starting the combustion engine is imminent.

11. The method according to claim 10, further comprising the step of completely engaging the at least one friction element when it is not determined, from at least one of the charge condition of the battery and the reserve torque of the electric motor, that starting the combustion engine is imminent.

12. The method according to claim 7, further comprising the step of operating the friction element, which is arranged between the electric motor and the drive output by friction force, at the slipping limit when the motor vehicle is creeping, such that a torque determined by an anticipatory-control-dependent torque that is to be transmitted by the friction element is set, and a torque that depends on a speed difference regulation is superimposed on the anticipatory-control-dependent torque in such manner that a sum of the anticipatory-control-dependent torque and a speed-difference-regulation-dependent torque does not exceed a maximum permissible torque.

13. A method of operating a motor vehicle drive train comprising at least a hybrid drive with a combustion engine and an electric motor, a transmission being arranged between the hybrid drive and a drive output, and a first clutch arranged between the combustion engine and the electric motor, the method comprising the steps of: electrically driving the drive train with the electric motor while the combustion engine is turned off;
determining if starting the combustion engine is imminent from at least one of a charge condition of a battery and a reserve torque of the electric motor; and
operating a second clutch, which is arranged between the hybrid drive and the drive output, at a slipping limit, if it is determined that starting the combustion engine is imminent;
engaging the first clutch to start the combustion engine.

14. The method according to claim 13, further comprising the step of operating the second clutch at the slipping limit such that a torque determined by anticipatory control that is to be transmitted by the friction element is set, and a torque that depends on a speed difference regulation is superimposed on the anticipatory-control-dependent torque, in such manner that a sum of the anticipatory-control-dependent torque and a speed-difference-regulation-dependent torque does not exceed a maximum permissible torque.
